(19) United States
(12) Patent Application Publication
(10) Pub. No.: US 2018/0371971 A1
(43) Pub. Date: Dec. 27, 2018

(54) FAULT DETECTION DEVICE FOR INTERNAL COMBUSTION ENGINE

(71) Applicant: DENSO CORPORATION, Kariya-city, Aichi-pref. (JP)

(72) Inventors: Kosuke NAKANO, Kariya-city (JP); Masanori KUROSAWA, Kariya-city (JP)

(21) Appl. No.: 16/063,421

(22) PCT Filed: Oct. 28, 2016
(86) PCT No.: PCT/JP2016/082006

§ 371 Date: Jun. 18, 2018

(30) Foreign Application Priority Data
Dec. 21, 2015 (JP) 2015-248327

(51) Int. Cl. F01M 13/00; F02D 23/00; F02D 41/00; F02M 35/10; G01M 15/09; G01M 15/04

(52) U.S. Cl. CPC F01M 13/00; F02D 23/00; F02D 41/003; F02M 35/10006; F02M 35/10157; F01M 2250/60; G01M 15/09; G01M 15/048; F02D 2200/021; F01M 2013/0083; F02M 35/10222

(57) ABSTRACT

A fault detection unit of an internal combustion engine includes a recirculation pipe connected with an upstream-side part of an intake pipe of the internal combustion engine upstream of a supercharger, the recirculation pipe to supply an evaporated fuel that is unburned and is generated in the internal combustion engine to the intake pipe, and a fault detection unit to detect a leakage occurrence of the recirculation pipe based on a crank-case inner pressure of the internal combustion engine when the internal combustion engine is operating in a specified operation condition that the crank-case inner pressure is a positive pressure.

### CROSS REFERENCE TO RELATED APPLICATION

This application is based on Japanese Patent Application No. 2015-248327 filed on Dec. 21, 2015, the disclosure of which is incorporated herein by reference.

### TECHNICAL FIELD

The present disclosure relates to a fault detection device of an internal combustion engine which detects a leakage occurrence of a recirculation pipe supplying an evaporated fuel to a position of an intake pipe of the internal combustion engine upstream of a supercharger.

### BACKGROUND ART

It is known that a positive crankcase ventilation device (PCV device) that is a device forcibly exchange gas in a crank case in an internal combustion engine is provided for an object to suppress an environment deterioration caused by a fuel component that is diluted (mixed) in an engine oil and volatilizes to the atmosphere. As the PCV device, for example, according to Patent Literature 1, a device that an evaporated fuel (blow-by gas) in a crank case can be returned to a combustion chamber of an engine again to cause a recombustion without being discharged to the atmosphere by returning the evaporated fuel to a surge tank of an intake system through a recirculation pipe is disclosed. The device disclosed in Patent Literature 1 determines a leakage fault of the recirculation pipe that recirculates the evaporated fuel to the surge tank by detecting a lean deviation of an air-fuel ratio or a misfire in a region where a pressure in the surge tank is a negative pressure.

### PRIOR ART LITERATURES

### Patent Literature

Patent Literature 1: JP2006-177288A

### SUMMARY OF INVENTION

However, it is known that a downsizing that miniaturizes a discharge quantity of the engine is used as a recent fuel-consumption improvement policy. It is known that the engine that is downsized is provided with a supercharger to obtain an output performance that is at the same level of a high discharge quantity. The engine with the supercharger can correct the output decreased by the downsizing by using the supercharger. The supercharger uses a kinematic energy of a combustion gas discharged from the engine to drive a turbine and compresses an air for the combustion by a compressor driven in association with the turbine. The air for the combustion that is compressed by the compressor is supplied to the combustion chamber through an intake pipe.

In the engine with the supercharger, when an operation time period where the engine is in a negative pressure region decreases or the engine is operating in a supercharge region, a pressure in a position of the intake pipe downstream of the compressor becomes a positive pressure by a driving of the compressor. Since a pressure in the crank case also becomes a positive pressure when the engine is operating in the supercharge region, it is necessary that the recirculation pipe that supplies the evaporated fuel is connected with a position of the intake pipe where a pressure in the position is relatively low. Specifically, the position is a position of the intake pipe upstream of the compressor. According to the above configuration, even in the supercharge region where the pressure in the crank case and the pressure in the surge tank become positive pressures, the evaporated fuel can be returned to the combustion chamber again and can cause the recombustion.

However, in the engine with the supercharger that has the configuration of the recirculation pipe, the leakage fault of the recirculation pipe cannot be detected according to a leakage determination processing disclosed in Patent Literature 1. Since a pressure upstream of a throttle valve becomes in a slight negative pressure condition according to a pressure loss caused by the atmosphere or an air cleaner without respect to an operation region of a supercharge or a non-supercharge, a lean deviation of an air-fuel ratio does not occur in the leakage fault of the recirculation pipe.

The present disclosure is made in view of the above matters, and it is an object of the present disclosure to provide a fault detection device of an internal combustion engine which can detect a fault of a recirculation pipe supplying an evaporated fuel to a position of an intake pipe of the internal combustion engine upstream of a supercharger with a high precision.

To solve the above matters, the fault detection device of the internal combustion engine according to the present disclosure includes a recirculation pipe (32) connected with an upstream-side part of an intake pipe (21) of the internal combustion engine (100) upstream of a supercharger (23), the recirculation pipe to supply an evaporated fuel that is unburned and is generated in the internal combustion engine to the intake pipe, and a fault detection unit (10) to detect a leakage occurrence of the recirculation pipe based on a crank-case inner pressure of the internal combustion engine when the internal combustion engine is operating in a specified operation condition that the crank-case inner pressure is a positive pressure.

When one leakage fault is occurring at the recirculation pipe in the specified operation condition that the crank-case inner pressure of the internal combustion engine is a positive pressure, the recirculation pipe communicates the atmosphere, and a pressure difference between two end parts of the recirculation pipe becomes relatively small comparing the pressure difference in the normal state. Thus, a discharge quantity of the evaporated fuel that is discharged from the internal combustion engine through the recirculation pipe becomes relatively small, and the crank-case inner pressure becomes relatively high. In other words, a significant difference occurs in inner pressure of the crank case based on whether the leakage fault occurs or not. The fault detection device of the internal combustion engine according to the present disclosure can detect the leakage occurrence of the recirculation pipe based on the crank-case inner pressure with a high precision, by using a characteristic of the crank-case inner pressure.

According to the present disclosure, the fault detection device of the internal combustion engine which can detect the fault of the recirculation pipe supplying the evaporated fuel to the position of the intake pipe of the internal combustion engine upstream of the supercharger with a high precision can be provided.

### BRIEF DESCRIPTION OF DRAWINGS

FIG. 1 is a schematic diagram showing an outline of a vehicle to which a fault detection device of an internal combustion engine is applied, according to a first embodiment.

FIG. 2 is a graph showing characteristics of a hydraulic pressure of an engine oil having a correlation with a crank-case inner pressure, in a supercharge operation when a second PCV pipe is in a normal state and the second PCV pipe is in a leakage fault state.

FIG. 3 is a flowchart showing a diagnosis processing of a leakage fault of the second PCV pipe, according to the first embodiment.

FIG. 4 is a schematic diagram showing the outline of the vehicle to which the fault detection device of the internal combustion engine is applied, according to a second embodiment.

FIG. 5 is a graph showing characteristics of the crank-case inner pressure in the supercharge operation when the second PCV pipe is in the normal state and the second PCV pipe is in the leakage fault state.

FIG. 6 is a flowchart showing the diagnosis processing of the leakage fault of the second PCV pipe, according to the second embodiment.

### DESCRIPTION OF EMBODIMENTS

Embodiments of the present disclosure will be described hereafter referring to drawings. The substantially same parts or components as those in the embodiments are indicated with the same reference numerals and the same descriptions may be omitted.

### First Embodiment

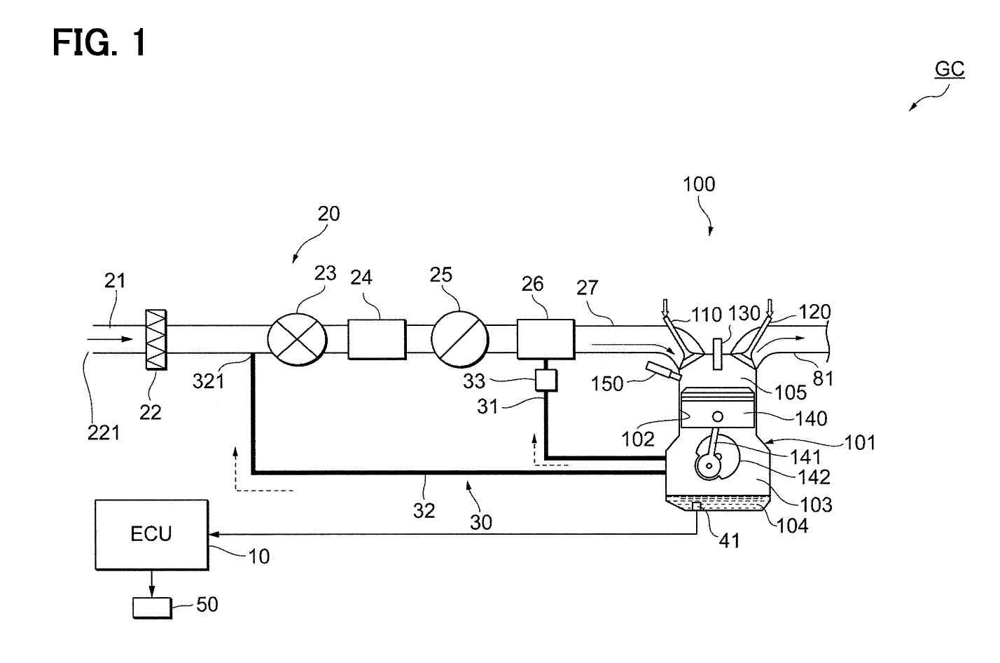

A first embodiment will be described referring to FIGS. 1 to 3. According to the first embodiment, a constitution of a vehicle GC to which a fault detection device of an internal combustion engine is applied will be described referring to FIG. 1. As shown in FIG. 1, the vehicle GC includes an electronic control unit (ECU) 10, an engine 100, an intake system 20 and a PCV system 30.

The engine 100 is an internal combustion engine that uses a gasoline as a fuel. The engine 100 is located in an engine room of the vehicle GC. The engine 100 includes multiple cylinders. Since each of the cylinders has the same configuration, a single cylinder is shown in FIG. 1.

A cylinder 102 that is a cylindrical shape and a crank case 103 are located in a cylinder block 101 of each of the cylinders of the engine 100. The crank case 103 is located at a position lower relative to the cylinder 102. The cylinder 102 receives a piston 140 that is slidable relative to the cylinder 102 in an up-down direction that is a vertical direction in figures. The piston 140 will be described later. An oil pan 104 that stores an engine oil (operation oil) is located in a lower part of the crank case 103. In the cylinder 102, cylinder wall surfaces and an upper surface of the piston 140 partition a combustion chamber 105. Each of the cylinders of the engine 100 includes an intake valve 110, an exhaust valve 120, an ignition plug 130, the piston 140 and an injector 150.

The intake valve 110 is a valve located at a connection part between an intake pipe 21 and the combustion chamber 105. A supply of an air to the combustion chamber 105 is executed in response to the intake valve 110 becoming in an open state. The supply of the air to the combustion chamber 105 is stopped in response to the intake valve 110 becoming in a closed state.

The exhaust valve 120 is a valve located at a connection part between an exhaust pipe 81 and the combustion chamber 105. A discharge of a combustion gas from the combustion chamber 105 to the exhaust pipe 81 is executed in response to the exhaust valve 120 becoming in the open state. The discharge of the combustion gas from the combustion chamber 105 to the exhaust pipe 81 is stopped in response to the intake valve 110 becoming in the closed state.

The ignition plug 130 is an apparatus to ignite a mixture gas including the fuel and the air in the combustion chamber 105 by generating a spark. The ECU 10 controls a timing that an ignition is executed by the ignition plug 130. In other words, the ECU 10 controls a timing that a combustion stroke starts.

The piston 140 is a component that is upwardly and downwardly slidable relative to the cylinder 102. In a compression stroke of each of the cylinders of the engine 100, a volume of the combustion chamber 105 decreases in response to the piston 140 moving upwardly. In the combustion stroke of each of the cylinders of the engine 100, the piston 140 is pressed downwardly by a combustion of the mixture gas in the combustion chamber 105. A connecting rod 141 and a crank shaft 142 are located in the crank case 103 lower relative to the piston 140. A slidable movement of the piston 140 is converted into a rotational motion by the crank shaft 142. Thus, the combustion of the fuel in the combustion chamber 105 is converted into a driving force of the vehicle GC.

The injector 150 is an on-off valve that injects the fuel into the combustion chamber 105. The ECU 10 controls an on-off operation of the injector 150. In other words, the ECU 10 controls a timing that the fuel is supplied to the combustion chamber 105 or a supply quantity of the fuel supplied to the combustion chamber 105.

The intake system 20 is a component that supplies air for combustion to each of the cylinders of the engine 100. The intake system 20 includes the intake pipe 21, an air element 22, a compressor 23 (supercharger), an intercooler 24, a throttle valve 25 and a surge tank 26.

The intake pipe 21 is a component that is a tubular shape and includes a passage therein. The intake pipe 21 includes an intake manifold 27 that branches into multiple pipes. The intake manifold 27 is located at a downstream end part of the intake pipe 21. The intake pipe 21 draws air of an exterior of the vehicle GC from an end part 211 and introduces the air to each of the cylinders of the engine 100 by dividing at the intake manifold 27.

The air element 22 is a component that is a filter shape and removes a foreign matter from a fluid passing through the air element 22. The air element 22 is located at the intake pipe 21. Thus, the air element 22 removes a foreign matter in the air that is drawn from the exterior of the vehicle GC and is supplied to the engine 100.

The compressor 23 constitutes a part of the supercharger and is a fluid machine that compresses the fluid by rotating. The compressor 23 is located at a position of the intake pipe 21 downstream of the air element 22. The compressor 23 is connected with a turbine that is not shown and constitutes a part of the supercharger. The turbine is a prime mover that converts an energy included in the fluid into a mechanical power. The turbine is located in the exhaust pipe 81. When the combustion gas generated in the combustion stroke of the engine 100 flows through the exhaust pipe 81, the turbine rotates by using the energy of the combustion gas. A rotational torque of the turbine is transmitted to the compressor 23 by a shaft that is not shown. Thus, the compressor 23 rotates, to suction and compress the fluid at an upstream region of the intake pipe 21 and to supply the fluid to a downstream region of the intake pipe 21.

The intercooler 24 is a heat exchanger that is located at a position of the intake pipe 21 downstream of the compressor 23. The intercooler 24 includes a passage therein, and the passage is not shown. The fluid that becomes at a high temperature in response to a compression of the compressor 23 is supplied to the passage of the intercooler 24. The air flowing through the passage dissipates heat in response to a heat exchange between the air flowing through the passage and the air flowing through an exterior of the intercooler 24, and a temperature of the air flowing through the passage decreases.

The throttle valve 25 is an on-off valve that is located at a position of the intake pipe 21 downstream of the intercooler 24. The throttle valve 25 includes an electric motor and a valve body which are not shown. The electric motor drives based on a control signal that is received from the ECU 10 and will be described later, and causes to valve body to move. When the valve body moves, an opening degree of an inner passage of the throttle valve 25 is adjusted.

The surge tank 26 is an apparatus that is a container shape and is located at a position of the intake pipe 21 downstream of the throttle valve 25. A cross-sectional area in the surge tank 26 is greater than cross-sectional areas of other parts of the intake pipe 21. Thus, when an unintentional pressure change occurs in one cylinder of the engine 100, a bad influence to other cylinders can be eased.

The PCV system 30 is a component that supplies an evaporated fuel (hereafter, the evaporated fuel is referred to as “blow-by gas”) that is a gasoline stored in the crank case 103 of the engine 100 in a gaseous state to the intake pipe 21 or the surge tank 26. The PCV system 30 includes a first PCV pipe 31 and a second PCV pipe 32.

The first PCV pipe 31 is a component that is a tubular shape and includes a passage therein. The first PCV pipe 31 includes one end part that is connected with the crank case 103 of the engine 100 and the other end part that is connected with the surge tank 26. Thus, the crank case 103 of the engine 100 and the surge tank 26 communicate with each other through the first PCV pipe 31. A PCV valve 33 is located at an intermediate part of the first PCV pipe 31. The PCV valve 33 is a differential-pressure operation valve that an opening degree of the differential-pressure operation valve is automatically adjusted according to a difference between a pressure in the crank case 103 and a pressure in the surge tank 26. By an adjustment of the opening degree of the PCV valve 33, a back flow of an intake air from the surge tank 26 to the crank case 103 is prevented and a flow rate of the blow-by gas introduced from the crank case 103 to the surge tank 26.

The second PCV pipe 32 is a component that is a tubular shape and includes a passage therein. The second PCV pipe 32 includes one end part that is connected with the crank case 103 of the engine 100 and the other end part that is connected with the intake pipe 21. Specifically, a connection part 321 between the other end part of the second PCV pipe 32 and the intake pipe 21 is located at a position of the intake pipe 21 upstream of the compressor 23 and downstream of the air element 22.

Next, functions of the PCV system 30 having the above configuration will be described. In the engine 100, it is possible that the evaporated fuel (blow-by fuel) that is unburned in the combustion chamber 105 is leaked to the crank case 103 from a gap between the cylinder 102 and the piston 140. Specifically, when a clearance of a slidable part between a wall surface of the cylinder 102 and the piston 140 is relatively large such as a case before a warming-up of the engine 100 is completed or when an inner pressure of the cylinder is high in a normal operation of the engine 100, the fuel is leaked from the combustion chamber 105 to the crank case 103 through the gap of the slidable part between the cylinder wall surface and the piston 140. Then, the fuel is mixed with the engine oil in the oil pan 104 to dilute the engine oil. In a state that an oil temperature of an engine lubricating oil is greater than or equal to a value, the fuel mixed with the engine oil is vaporized, and the evaporated fuel that is vaporized is stored in the crank case 103 as the blow-by gas. It is possible that the blow-by gas stored in the crank case 103 leads to a deterioration of the engine oil or a corrosion of a metal. To suppress the above malfunctions, the PCV system 30 functions to discharge the blow-by gas from the crank case 103 through the first PCV pipe 31 or the second PCV pipe 32 and to return the blow-by gas to the intake pipe 21.

When the engine 100 is operating without activating the compressor 23, a negative pressure generated in response to the fluid flowing through the intake pipe 21 applies the crank case 103 through the first PCV pipe 31 and the second PCV pipe 32. Thus, the blow-by gas in the crank case 103 is discharged to the surge tank 26 through the first PCV pipe 31 and is discharged to the connection part 321 of the intake pipe 21 through the second PCV pipe 32.

When the engine 100 is operating while the compressor 23 is activated, that is, when the engine 100 executes a supercharge operation, the intake air is compressed by the compressor 23. Thus, the pressure in the surge tank 26 downstream of the compressor 23 becomes a positive pressure. In this case, since a pressure is applied to the first PCV pipe 31, the opening degree of the PCV valve 33 becomes smaller, and the pressure in the crank case 103 of the engine 100 becomes a positive pressure. In a region of the intake pipe 21 upstream of the compressor 23, a pressure in the intake pipe 21 becomes relatively low in response to a force of the compressor 23 of the supercharger suctioning the intake air, and a pressure difference occurs between the pressure in the intake pipe 21 and an inner pressure of the crank case. According to the present embodiment, the inner pressure of the crank case is referred to as a crank-case inner pressure. Since the pressure difference applies to the crank case 103 through the second PCV pipe 32, the blow-by gas is discharged from the crank case 103 and is introduced to the intake pipe 21 through the second PCV pipe 32. Thus, in the supercharge operation of the engine 100, the blow-by gas in the crank case 103 is discharged to a position of the connection part 321 in the intake pipe 21 through the second PCV pipe 32.

The blow-by gas discharge from the crank case 103 of the engine 100 flows into the intake pipe 21 and joins the air drawn from the end part 211. A mixture gas including the blow-by gas and the air flows through the intake pipe 21 and is supplied to the combustion chamber 105 of each of the cylinders of the engine 100. Thus, the blow-by gas is used in an operation of the engine 100 without being discharged to the atmosphere and a fuel consumption of the engine 100 can be improved.

The ECU 10 is a component that controls operations of vehicle devices of the vehicle GC including the engine 100, the intake system 20 and the PCV system 30, based on various information acquired from sensors of the vehicle GC. The ECU 10 is electrically connected with various sensors including a hydraulic pressure sensor 41. The ECU 10 is also electrically connected with vehicle devices including the engine 100, the throttle valve 25, the supercharger and a notification device 50, and sends control signals to the vehicle devices to control the operation of the engine 100.

The hydraulic pressure sensor 41 is a sensor that generates and sends a signal corresponding to a hydraulic pressure of the engine oil (operation oil) of the engine 100. The hydraulic pressure sensor 41, for example, is located in the oil pan 104 in the lower part of the crank case 103 of the engine 100 as shown in FIG. 1, or is located in a part of a pipe through which the engine oil is discharged and recirculated from the oil pan 104.

The notification device 50 is a device that executes various notifications to a passenger of the vehicle GC. The notification device 50 is constituted by a known apparatus such as a display panel or a buzzer. The ECU 10 sends the control signal to control an operation of the notification device 50.

The ECU 10 is physically constituted by a CPU, a ROM, a RAM and an input-output interface, as a computer system. The above functions of the ECU 10 are achieved in response to a loading or a writing of data in the RAM or the ROM according to an application program that is stored in the ROM and then is loaded to the RAM and is executed by the CPU.

According to the present embodiment, the second PCV pipe 32 functions as “a recirculation pipe that is connected with a position of the intake pipe 21 of the engine 100 upstream of the compressor 23 (supercharger) and supplies the evaporated fuel (blow-by gas) that is unburned and is generated in the engine 100 to the intake pipe 21”. The ECU 10 and the hydraulic pressure sensor 41 function as “a fault detection unit that detects a leakage occurrence of the second PCV pipe 32”. The second PCV pipe 32, the ECU 10 and the hydraulic pressure sensor 41 function as the fault detection device of the internal combustion engine according to the present embodiment.

In the vehicle GC having the above configuration, it is possible that a malfunction relating to a processing of the blow-by gas occurs according to a fault occurring at the second PCV pipe 32. In other words, since the second PCV pipe 32 that is expected to be connected with the intake pipe 21 in a normal state is removed from the intake pipe 21 (hereafter, “pipe removing”) or a leakage occurs due to a damage at the connection part of the intake pipe 21 or at an inner wall of the intake pipe 21 (hereafter, “pipe leakage”), it is possible that the blow-by gas flowing through the second PCV pipe 32 is discharged to the atmosphere. Hereafter, the above phenomenons are referred to as a leakage fault. Since it is necessary to execute a correction at a dealer or a maintenance factory when the leakage fault occurs, it is necessary to rapidly detect the fault and notify a user of the vehicle GC that the fault occurs. An occurrence of the leakage fault is referred to as “leakage occurrence”.

For a recirculation pipe connected with the surge tank 26 and the crank case 103 which is equivalent to the first PCV pipe 31 of the present embodiment, a leakage fault determination processing to detect the leakage occurrence based on an air-fuel ratio deviation quantity as Patent Literature 1, for example, is proposed. However, since the second PCV pipe 32 includes the connection part 321 that is between the intake pipe 21 and the second PCV pipe 32 and is located at a position of the intake pipe 21 upstream of the throttle valve 25, the leakage fault determination processing cannot be applied to the second PCV pipe 32. Since the pressure in the intake pipe 21 upstream of the throttle valve 25 becomes in a slight negative pressure condition according to a pressure loss caused by the atmosphere or the air element 22 without respect to an operation region of a supercharge or a non-supercharge, a lean deviation of an air-fuel ratio does not occur in the leakage fault of the second PCV pipe 32.

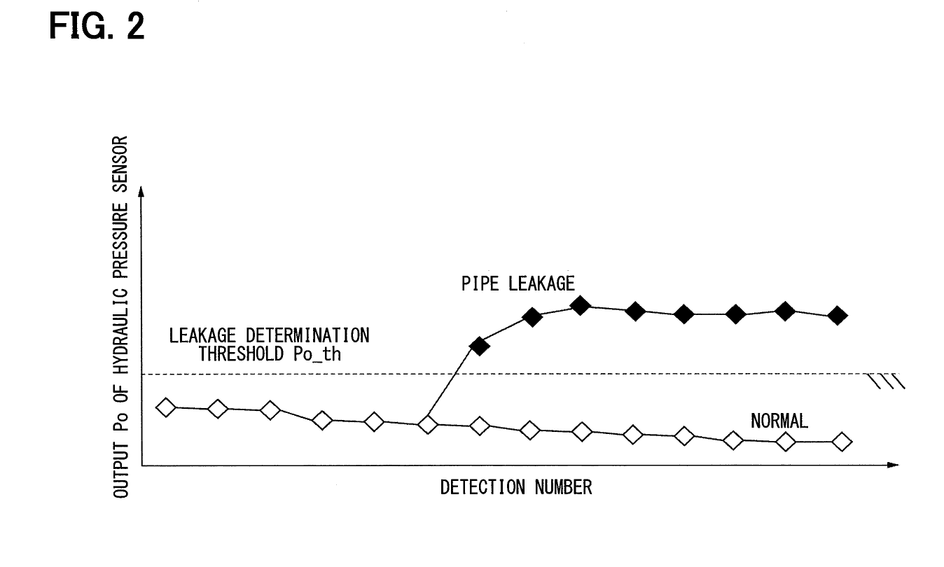

According to the present embodiment, the ECU 10 detects the leakage occurrence of the second PCV pipe 32 based on a pressure (inner pressure of the crank case) of an interior of the crank case 103 when the engine 100 is in the supercharge operation. A concept of the leakage fault determination processing according to the present embodiment will be described referring to FIG. 2. FIG. 2 shows characteristics of the hydraulic pressure of the engine oil having a correlation with the crank-case inner pressure, in the supercharge operation when the second PCV pipe 32 is in the normal state and the second PCV pipe 32 is in a leakage fault state. As shown in FIG. 2, a white plot line indicates the hydraulic pressure (hydraulic pressure Po output by the hydraulic pressure sensor 41) in the normal state, and a black plot line indicates a characteristic of the hydraulic pressure in the leakage fault state.

As shown in FIG. 2, the hydraulic pressure of the engine oil has a tendency to relatively increase when the leakage fault occurs at the second PCV pipe 32 comparing the hydraulic pressure in the normal state. In other words, the crank-case inner pressure has a tendency to relatively increase when the leakage fault occurs at the second PCV pipe 32 comparing the crank-case inner pressure in the normal state. Reasons that the crank-case inner pressure becomes relatively high are as follows.

In the supercharge operation, since the pressure in the connection part 321 between the second PCV pipe 32 and the intake pipe 21 in the normal state becomes a negative pressure, a pressure in a discharge source (crank case 103) of the blow-by gas becomes a positive pressure, and a pressure in a discharge target through the second PCV pipe 32 becomes a negative pressure. Since the second PCV pipe 32 discharges the blow-by gas to the atmosphere in the leakage fault, the pressure in the discharge source of the blow-by gas becomes a positive pressure, and the pressure in the discharge target becomes an atmospheric pressure. Thus, when the leakage fault occurs at the second PCV pipe 32, a pressure difference between the pressure in the discharge source and the pressure in the discharge target of the blow-by gas becomes relatively smaller than the pressure difference in the normal state. Thus, a discharge quantity of the blow-by gas becomes relatively small, and the crank-case inner pressure becomes relatively high. In other words, in the supercharge operation, a significant difference occurs at the crank-case inner pressure based on whether the leakage fault of the second PCV pipe 32 occurs or not.

Since the hydraulic pressure of the engine oil has a correlation with the crank-case inner pressure, a significant difference also occurs at the hydraulic pressure of the engine oil based on whether the leakage fault of the second PCV pipe 32 occurs or not in the supercharge operation as shown in FIG. 2. According to the first embodiment, the ECU 10 executes a determination of the leakage fault by using the hydraulic pressure of the engine oil detected by the hydraulic pressure sensor 41 in the supercharge operation as information corresponding to the crank-case inner pressure.

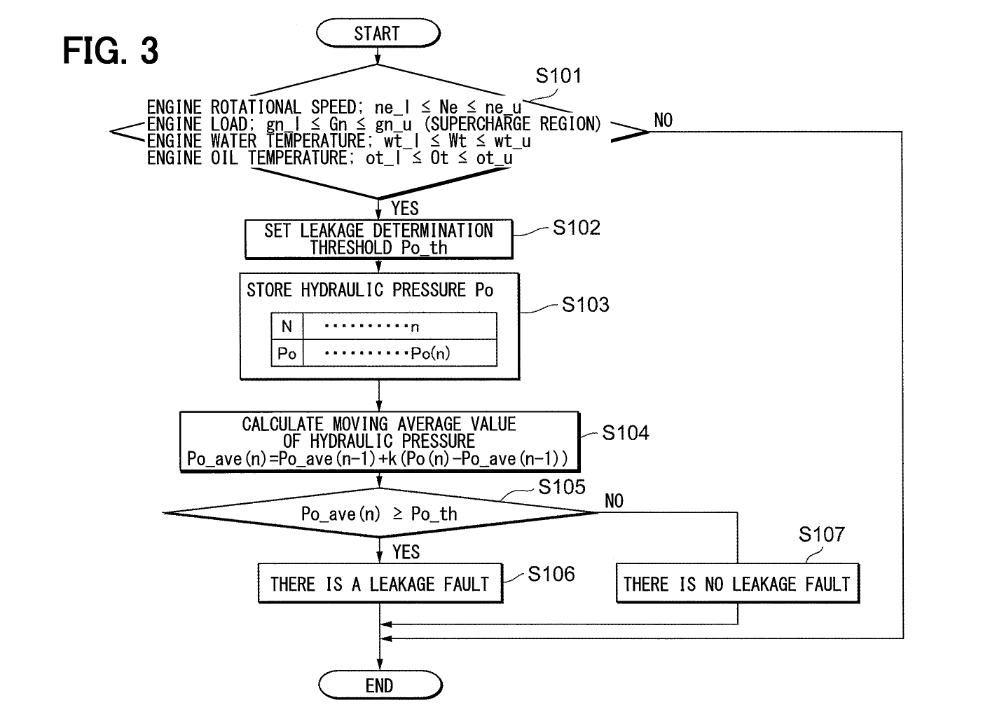

The ECU 10 executes a processing to diagnose whether the leakage fault of the second PCV pipe 32 occurs or not. Referring to a flowchart of FIG. 3, a determination processing of the leakage fault of the second PCV pipe 32 executed by the ECU 10 in the first embodiment will be described. The determination processing of the leakage fault that is a fault determination processing shown in FIG. 3, for example, can be executed at a timing that the supercharger is firstly caused to drive after a start of the engine 100.

At step S101, it is determined that an executable condition of the fault determination processing is met. The executable condition is as follows.

The executable condition includes a condition that an engine rotational speed Ne is greater than or equal to a lower limit ne_l and the engine rotational speed Ne is less than or equal to an upper limit ne_u (ne_l≤Ne≤ne_u).

The executable condition further includes a condition that an engine load Gn is greater than or equal to a lower limit gn_l and the engine load Gn is less than or equal to an upper limit gn_u, that is, a condition that the engine load Gn is in a supercharge region (gn_l≤Gn≤gn_u).

The executable condition further includes a condition that an engine water temperature Wt is greater than or equal to a lower limit wt_l and the engine water temperature Wt is less than or equal to an upper limit wt_u (wt_l≤Wt≤wt_u).

The executable condition further includes a condition that an engine oil temperature Ot is greater than or equal to a lower limit ot_l and the engine oil temperature Ot is less than or equal to an upper limit ot_u (ot_l≤Ne≤ot_u).

As a result of a determination at step S101, when all of the above conditions are met (step S101: Yes), the process proceeds to step S102. Further, when at least one of the above conditions is not met (step S101: No), the present control flow is terminated.

At step S102, a leakage determination threshold Po_th is set. The leakage determination threshold Po_th, for example, as shown in FIG. 2, is set to a value that is greater than the hydraulic pressure in the normal state and is less than the hydraulic pressure in the leakage fault state, such that the normal state of a connection of the second PCV pipe 32 and the leakage fault state of the connection of the second PCV pipe 32 can be divided appropriately. The leakage determination threshold Po_th may be a fixed value, or may be a variable value that varies according to the engine rotational speed Ne, the engine load Gn, the engine water temperature Wt, or the engine oil temperature Ot mentioned at step S101. When a processing at step S102 is completed, the process proceeds to step S103.

At step S103, the hydraulic pressure Po of the engine oil is detected, and the hydraulic pressure Po is stored together with values of the hydraulic pressures Po in preceding n steps. The ECU 10 detects the hydraulic pressure Po based on the signal input from the hydraulic pressure sensor 41, and stores the hydraulic pressure Po as an n-th hydraulic pressure Po(n). When a processing at step S103 is completed, the process proceeds to step S104.

At step S104, a moving average value Po_ave(n) of the hydraulic pressure Po detected at step S103 is calculated. The ECU 10 calculates the moving average value Po_ave(n) in the present processing according to a formula (1) by using the hydraulic pressure Po(N) (N=1, 2, 3, . . . , n) in preceding n steps that are stored. When a processing at step S104 is completed, the process proceeds to step S105.

Po_ave(n)=Po_ave(n−1)+k×{Po(n)−Po_ave (n−1)} (1)

At step S105, it is determined whether the moving average value Po_ave(n) of the hydraulic pressures calculated at step S104 is greater than or equal to the leakage determination threshold Po_th set at step S102 (Po_ave(n)≥Po_th). As the description referring to FIG. 2, since the hydraulic pressure has the tendency to relatively increase when the leakage fault occurs at the second PCV pipe 32 comparing the hydraulic pressure in the normal state, the hydraulic pressure becomes greater than or equal to the leakage determination threshold Po_th.

As a result of a determination at step S105, when the moving average value Po_ave(n) is greater than or equal to the leakage determination threshold Po_th (step S105: Yes), it is determined that the leakage fault is occurring at the second PCV pipe 32. In this case, at step S106, it is determined that “there is a leakage fault”, and the present control flow is terminated. The ECU 10 can execute a warning of the leakage fault occurrence to a driver of the vehicle GC through the notification device 50 and execute a processing at step S106.

As the result of the determination at step S105, when the moving average value Po_ave(n) is less than the leakage determination threshold Po_th (step S105: No), it is determined that the second PCV pipe 32 is normally connected with the intake pipe 21 and the crank case 103. In this case, at step S107, it is determined that “there is no leakage fault”, and the present control flow is terminated.

Next, effects of the fault detection device of the internal combustion engine according to the first embodiment will be described.

The fault detection device of the internal combustion engine according to the first embodiment is connected with an upstream-side part of the intake pipe 21 of the engine 100 upstream of the compressor 23 (supercharger). The fault detection device includes the second PCV pipe 32 that supplies the blow-by gas generated at the engine 100 to the intake pipe 21 and the ECU 10 that is the fault detection unit and detects the leakage occurrence of the second PCV pipe 32. When the engine 100 is in an operation condition that the engine 100 is being supercharged by the supercharger and the rotational speed Ne and the load Gn of the engine 100 are in predetermined ranges (ne_l≤Ne≤ne_u, gn_l ≤Gn≤gn_u), the ECU 10 detects the leakage occurrence of the second PCV pipe 32 in response to the crank-case inner pressure that is greater relative to the crank-case inner pressure in the normal state by a value greater than or equal to a predetermined value, based on the crank-case inner pressure of the engine 100.

As the above description, the crank-case inner pressure becomes a positive pressure in the supercharge operation of the engine 100. When the second PCV pipe 32 is normally connected with the intake pipe 21, the pressure in the upstream-side part of the intake pipe 21 upstream of the compressor 23 becomes a negative pressure. Thus, the blow-by gas in the crank case is discharged to the intake pipe 21. In this case, a differential pressure between a pressure (inner pressure of the crank case) in one end part of the second PCV pipe 32 and a pressure (inner pressure of the intake pipe 21) in the other end part of the second

PCV pipe 32 becomes relatively large. When one leakage fault is occurring at the second PCV pipe 32, the second PCV pipe 32 communicates the atmosphere, and the pressure in the other end part of the second PCV pipe 32 becomes equal to the atmospheric pressure.

In this case, since the pressure difference between two end parts of the second PCV pipe 32 becomes relatively small comparing the pressure difference in the normal state, a discharge quantity of the blow-by gas that is discharged from the crank case 103 through the second PCV pipe 32 becomes relatively small. Thus, the crank-case inner pressure becomes relatively high. In other words, a significant difference occurs in inner pressure of the crank case based on whether the leakage fault occurs or not. The fault detection device of the internal combustion engine according to the first embodiment can detect the leakage occurrence of the second PCV pipe 32 based on the crank-case inner pressure with a high precision, by using a characteristic of the crank-case inner pressure. Thus, the fault detection device of the internal combustion engine according to the first embodiment can detect a fault of the second PCV pipe 32 that supplies the blow-by gas to a position of the intake pipe 21 of the engine 100 upstream of the supercharger, with a high precision.

The fault detection device of the internal combustion engine according to the first embodiment further includes the hydraulic pressure sensor 41 that detects the hydraulic pressure of the operation oil of the engine 100. The ECU 10 that is the fault detection unit uses the hydraulic pressure Po detected by the hydraulic pressure sensor 41 as information corresponding to the crank-case inner pressure, and detects the leakage occurrence of the second PCV pipe 32 when the hydraulic pressure Pc is greater than or equal to the leakage determination threshold Po_th that is predetermined.

As the above description, since the hydraulic pressure Po of the operation oil of the engine 100 has a tendency that varies in association with the crank-case inner pressure, the behavior of the crank-case inner pressure can be obtained with a high precision by using the hydraulic pressure Po of the operation oil. Since the hydraulic pressure sensor 41 is generally located at the engine 100, the behavior of the crank-case inner pressure can be obtained with a simplified configuration where a new sensor that measures the crank-case inner pressure in unnecessary to be added.

In the fault detection device of the internal combustion engine according to the first embodiment, the ECU 10 that is the fault detection unit executes a determination whether the leakage occurrence exists or not when the water temperature Wt of a coolant of the engine 100 is greater than or equal to a predetermined value (lower limit wt_l) and the oil temperature Ot of the operation oil of the engine 100 is greater than or equal to a predetermined value (lower limit ot_l). Since the determination of the leakage fault can be executed after the engine 100 is sufficiently warmed up according to the above configuration, a determination precision can be improved.

According to the first embodiment, the hydraulic pressure Po of the engine oil is used as information corresponding to the crank-case inner pressure. However, other information having a correlation with a variation of the crank-case inner pressure may be used as information corresponding to the crank-case inner pressure.

### Second Embodiment

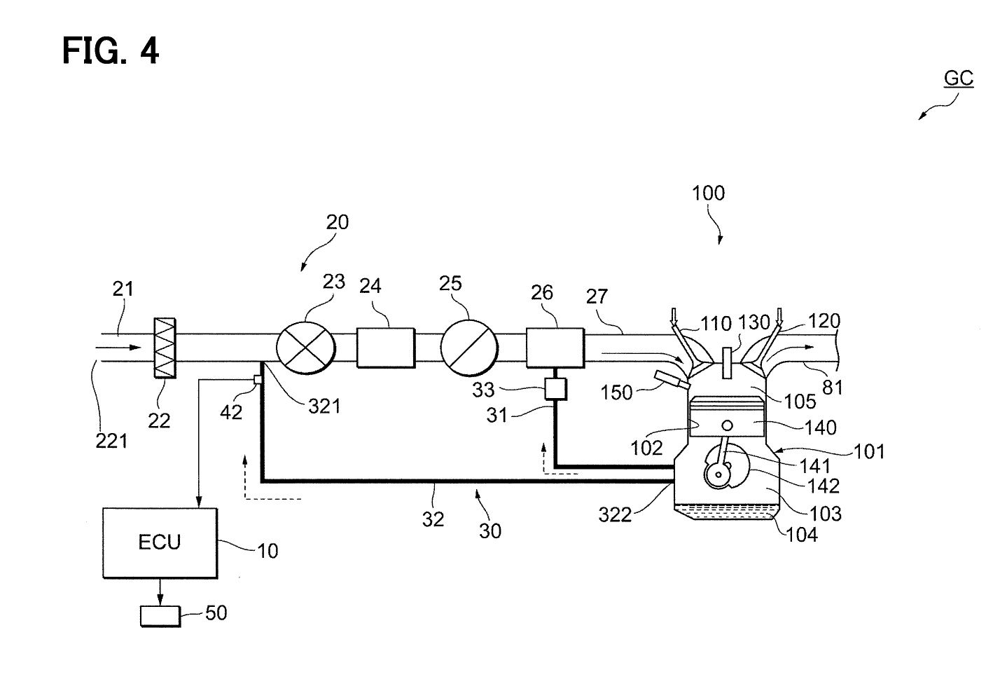

A second embodiment will be described referring to FIGS. 4 to 6. According to the second embodiment, matters that the crank-case inner pressure is directly measured, the determination of the leakage fault of the second PCV pipe 32 is executed by using the crank-case inner pressure that is measured are different from the first embodiment.

As shown in FIG. 4, the fault detection device of the internal combustion engine according to the second embodiment includes a pressure sensor 42. The pressure sensor 42 is a sensor that generates and sends a signal corresponding to the crank-case inner pressure. The pressure sensor 42, for example, as shown in FIG. 4, is located in the vicinity of the connection part 321 of the second PCV pipe 32 between the second PCV pipe 32 and the intake pipe 21.

An installation position of the pressure sensor 42 may be located in the vicinity of a connection part 322 of the second PCV pipe 32 between the second PCV pipe 32 and the crank case 103. It is highly likely that the pipe removing or the pipe leakage in the connection part 321, 322 leads to the leakage fault of the second PCV pipe 32, and it is highly likely that the variation of the crank-case inner pressure when the leakage fault occurs can be rapidly detected. The installation position of the pressure sensor 42 may be located at an arbitrary position between the connection parts 321, 322 of two ends of the second PCV pipe 32. When the pipe leakage generated due to a damage of an inner wall of the second PCV pipe 32 leads to the leakage fault of the second PCV pipe 32, the variation of the crank-case inner pressure when the leakage fault occurs can be rapidly detected.

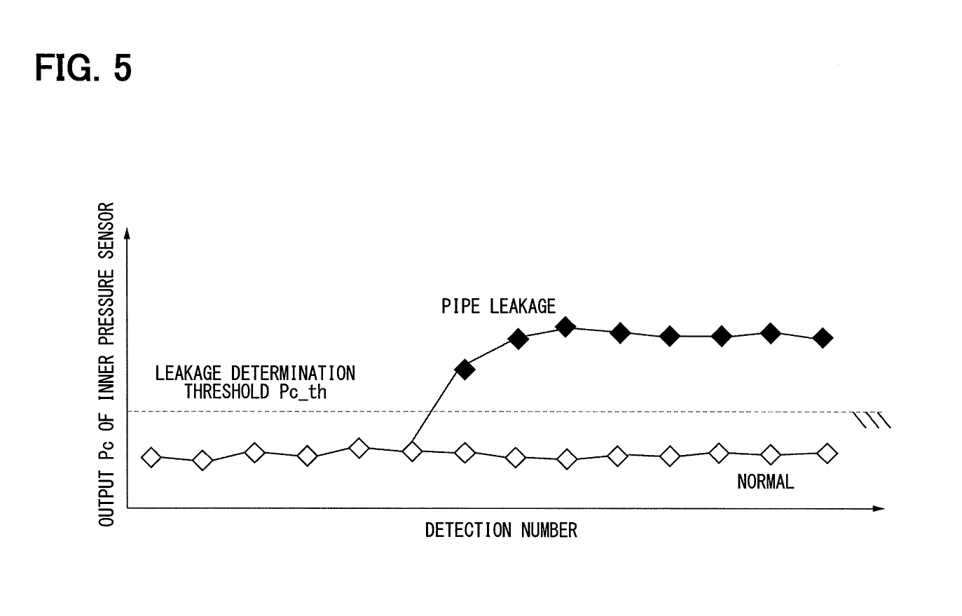

A concept of the leakage fault determination processing according to the present embodiment will be described referring to FIG. 5. FIG. 5 shows characteristics of the crank-case inner pressure in the supercharge operation when the second PCV pipe 32 is in the normal state and the second PCV pipe 32 is in the leakage fault state. As shown in FIG. 5, a white plot line indicates the crank-case inner pressure (crank-case inner pressure Pc output by the pressure sensor 42) in the normal state, and a black plot line indicates the characteristic of the crank-case inner pressure in the leakage fault state.

As the above description referring to FIG. 2, the crank-case inner pressure has a tendency to relatively increase when the leakage fault occurs at the second PCV pipe 32 comparing the crank-case inner pressure in the normal state. In other words, in the supercharge operation, a significant difference occurs at the crank-case inner pressure based on whether the leakage fault of the second PCV pipe 32 occurs or not. According to the second embodiment, the ECU 10 executes the determination of the leakage fault by using the crank-case inner pressure output by the pressure sensor 42 in the supercharge operation.

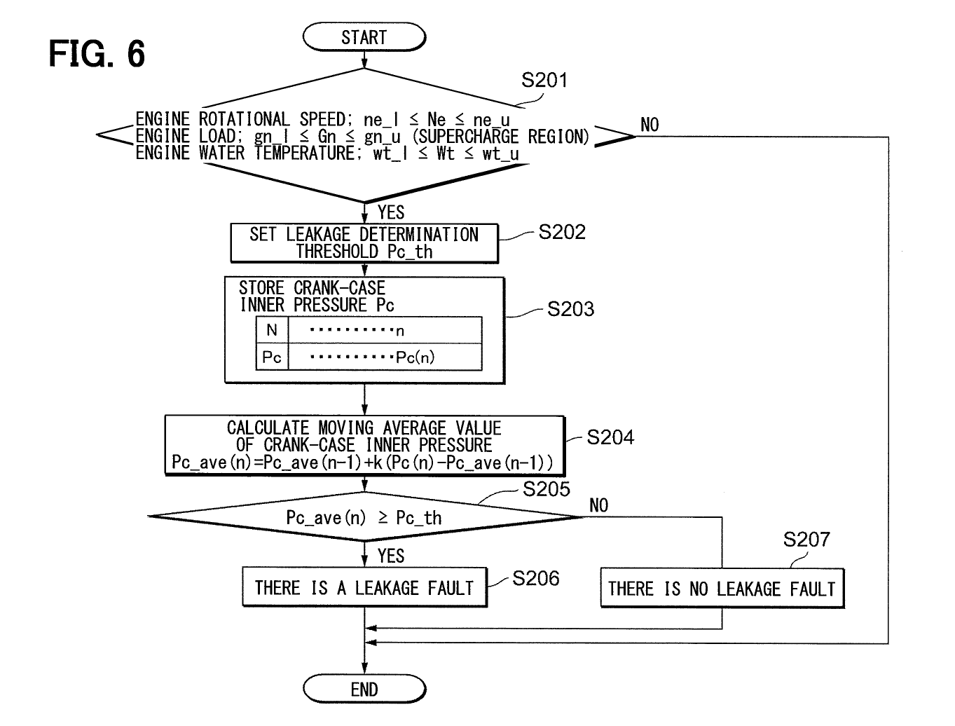

Referring to a flowchart of FIG. 6, the determination processing of the leakage fault of the second PCV pipe 32 executed by the ECU 10 in the second embodiment will be described. The determination processing of the leakage fault that is the fault determination processing shown in FIG. 6, for example, can be executed at a timing that the supercharger is firstly caused to drive after a start of the engine 100.

At step S201, it is determined that an executable condition of the fault determination processing is met. The executable condition is as follows (the condition relating to the engine oil temperature Ot is removed from step S101 of FIG. 2).

The executable condition includes the condition that the engine rotational speed Ne is greater than or equal to the lower limit ne_l and the engine rotational speed Ne is less than or equal to the upper limit ne_u (ne_l≤Ne≤ne_u).

The executable condition further includes the condition that the engine load Gn is greater than or equal to the lower limit gn_l and the engine load Gn is less than or equal to the upper limit gn_u, that is, the condition that the engine load Gn is in the supercharge region (gn_l≤Gn≤gn_u). The executable condition further includes the condition that the engine water temperature Wt is greater than or equal to the lower limit wt_l and the engine water temperature Wt is less than or equal to the upper limit wt_u (wt_l≤Wt≤wt_u).

As a result of a determination at step S201, when all of the above conditions are met (step S201: Yes), the process proceeds to step S202. Further, when at least one of the above conditions is not met (step S201: No), the present control flow is terminated.

At step S202, a leakage determination threshold Pc_th is set. The leakage determination threshold Pc_th, for example, as shown in FIG. 5, is set to a value that is greater than the crank-case inner pressure in the normal state and is less than the crank-case inner pressure in the leakage fault state, such that the normal state of the connection of the second PCV pipe 32 and the leakage fault state of the connection of the second PCV pipe 32 can be divided appropriately. The leakage determination threshold Pc_th may be a fixed value, or may be a variable value that varies according to the engine rotational speed Ne, the engine load Gn, or the engine water temperature Wt mentioned at step S201. When a processing at step S202 is completed, the process proceeds to step S203.

At step S203, the crank-case inner pressure Pc is detected, and the crank-case inner pressure Pc is stored together with values of the crank-case inner pressures Pc in preceding n steps. The ECU 10 detects the crank-case inner pressure Pc based on the signal input from the pressure sensor 42, and stores the crank-case inner pressure Pc as an n-th crank-case inner pressure Pc(n). When a processing at step S203 is completed, the process proceeds to step S204.

At step S204, a moving average value Pc_ave(n) of the crank-case inner pressure Pc detected at step S203 is calculated. The ECU 10 calculates the moving average value Pc_ave(n) in the present processing according to a formula (2) by using the crank-case inner pressure Pc(N) (N=1, 2, 3, . . . , n) in preceding n steps that are stored. When a processing at step S204 is completed, the process proceeds to step S205.

Pc_ave(n)=Pc_ave(n−1)+k×{Pc(n)−Pc_ave (n−1)} (2)

At step S205, it is determined whether the moving average value Pc_ave(n) of the crank-case inner pressures calculated at step S204 is greater than or equal to the leakage determination threshold Pc_th set at step S202 (Pc_ave(n)≥Pc_th). As the description referring to FIG. 5, since the crank-case inner pressure has the tendency to relatively increase when the leakage fault occurs at the second PCV pipe 32 comparing the crank-case inner pressure in the normal state, the crank-case inner pressure becomes greater than or equal to the leakage determination threshold Pc_th.

As a result of a determination at step S205, when the moving average value Pc_ave(n) is greater than or equal to the leakage determination threshold Pc_th (step S205: Yes), it is determined that the leakage fault is occurring at the second PCV pipe 32. In this case, at step S206, it is determined that “there is a leakage fault”, and the present control flow is terminated. The ECU 10 can execute a warning of the leakage fault occurrence to a driver of the vehicle GC through the notification device 50 and execute a processing at step S206.

As the result of the determination at step S205, when the moving average value Pc_ave(n) is less than the leakage determination threshold Pc_th (step S205: No), it is determined that the second PCV pipe 32 is normally connected with the intake pipe 21 and the crank case 103. In this case, at step S207, it is determined that “there is no leakage fault”, and the present control flow is terminated.

Similar to the first embodiment, since the fault detection device of the internal combustion engine according to the second embodiment has a configuration that the leakage occurrence of the second PCV pipe 32 is detected based on the crank-case inner pressure in the supercharge operation of the engine 100, the same effects as the first embodiment can be achieved.

The fault detection device of the internal combustion engine according to the second embodiment further includes the pressure sensor 42 that detects the crank-case inner pressure Pc. The ECU 10 that is the fault detection unit detects the leakage occurrence of the second PCV pipe 32 when the crank-case inner pressure Pc detected by the pressure sensor 42 is greater than or equal to the leakage determination threshold Pc_th that is predetermined.

Since the crank-case inner pressure can be directly measured by using the pressure sensor 42 according to the above configuration, the leakage occurrence of the second PCV pipe 32 can be determined with a higher precision based on the crank-case inner pressure.

The pressure sensor 42 is located at the connection part 321 of the second PCV pipe 32 between the second PCV pipe 32 and the intake pipe 21 or at the connection part 322 between the second PCV pipe 32 and the crank case 103 of the engine 100. The variation of the crank-case inner pressure caused by the leakage fault becomes remarkable in the vicinity of the connection part where the pipe is removed. The variation of the crank-case inner pressure in response to the occurrence of the leakage fault can be rapidly detected by arranging the installation position of the pressure sensor 42 in the vicinity of the connection part 321, 322.

In the fault detection device of the internal combustion engine according to the second embodiment, the ECU 10 that is the fault detection unit executes the determination whether the leakage occurrence exists or not when the water temperature Wt of the coolant of the engine 100 is greater than or equal to a predetermined value (lower limit wt_l). Since the determination of the leakage fault can be executed after the engine 100 is sufficiently warmed up according to the above configuration, a determination precision can be improved.

According to the above embodiments, a configuration where the determination processing of the leakage fault of the second PCV pipe 32 in the supercharge operation of the engine 100 is illustrated. However, when the engine 100 is operating in a specified operation condition that the crank-case inner pressure Pc of the engine 100 is a positive pressure, the present disclosure can be applied to a configuration where the leakage fault determination processing is executed in an operation other than the supercharge operation.

According to the above embodiments, a configuration where the moving average value of the oil pressure Po or the crank-case inner pressure Pc is compared with the leakage determination threshold to execute the determination of the leakage fault is illustrated. However, the present disclosure may be applied to a control processing that obtains the variation of the crank-case inner pressure or the oil pressure relative to the same in the normal state. For example, a value that is measured in the present cycle, or a value applied to a filter processing, may be compared with a threshold, instead of the moving average value. Further, a determination other than a comparison between one of the above values and a threshold may be used. For example, a deviation between a reference pressure in the normal state and a target value may be obtained.

According to the above embodiments, a configuration where a single leakage determination threshold is set to determine the leakage fault including the pipe removing and the pipe leakage is illustrated. However, the present disclosure can be applied to a configuration where multiple reasons of the leakage fault including the pipe removing and the pipe leakage are distinguished and determined. In this case, for example, multiple thresholds may be set.

As the above description, the embodiment of the present disclosure is described. However, the present disclosure is not limited to the above embodiment. Such changes and modifications are to be understood as being within the scope of the present disclosure as defined by the appended claims. The elements and their arrangements, materials, conditions, shapes, and the like included in the specific examples described above are not limited to those exemplified but can be modified as appropriate. In addition, while the various combinations and configurations, which are preferred, other combinations and configurations, including more, less or only a single element, are also within the spirit and scope of the present disclosure.

1. A fault detection device for an internal combustion engine, comprising:
a recirculation pipe connected with an upstream-side part of an intake pipe of the internal combustion engine upstream of a supercharger, the recirculation pipe to supply an evaporated fuel that is unburned and is generated in the internal combustion engine to the intake pipe; and
a fault detection unit to detect a leakage occurrence of the recirculation pipe based on a crank-case inner pressure of the internal combustion engine when the internal combustion engine is operating in a specified operation condition that the crank-case inner pressure is a positive pressure, wherein
the fault detection unit is to detect the leakage occurrence of the recirculation pipe when the crank-case inner pressure is greater relative to the crank-case inner pressure in a normal state by a value greater than or equal to a predetermined value.

2. (canceled)

3. The fault detection device for the internal combustion engine according to claim 1, further comprising:
a hydraulic pressure sensor to detect a hydraulic pressure of an operation oil of the internal combustion engine, wherein
the fault detection unit is to use the hydraulic pressure detected by the hydraulic pressure sensor as information corresponding to the crank-case inner pressure and is to detect the leakage occurrence of the recirculation pipe when the hydraulic pressure is greater than or equal to a threshold that is predetermined.

4. The fault detection device for the internal combustion engine according to claim 3, wherein
the fault detection unit is to execute a determination whether the leakage occurrence exists or not when a water temperature of a coolant of the internal combustion engine is greater than or equal to a predetermined value and an oil temperature of the operation oil of the internal combustion engine is greater than or equal to a predetermined value.

5. The fault detection device for the internal combustion engine according to claim 1, further comprising:
a pressure sensor to detect the crank-case inner pressure, wherein
the fault detection unit is to detect the leakage occurrence of the recirculation pipe when the crank-case inner pressure detected by the pressure sensor is greater than or equal to a threshold that is predetermined.

6. The fault detection device for the internal combustion engine according to claim 5, wherein
the pressure sensor is located at a connection part of the recirculation pipe between the recirculation pipe and the intake pipe or between the recirculation pipe and the internal combustion engine.

7. The fault detection device for the internal combustion engine according to claim 5, wherein
the fault detection unit is to execute a determination whether the leakage occurrence exists or not when a water temperature of a coolant of the internal combustion engine is greater than or equal to a predetermined value.

8. The fault detection device for the internal combustion engine according to claim 1, wherein
the specified operation condition is an operation condition that the internal combustion engine is being supercharged by the supercharger and a rotational speed and a load of the internal combustion engine are in predetermined ranges.
